(19) United States
(12) Patent Application Publication
(10) Pub. No.: US 2025/0362893 A1
(43) Pub. Date: Nov. 27, 2025

(54) SIMAFICATION OF COMPUTER PROGRAM CODE

(71) Applicant: Manycore Corporation, Covina, CA (US)

(72) Inventor: Nicolas Toper, Palo Alto, CA (US)

(21) Appl. No.: 19/215,558

(22) Filed: May 22, 2025

Related U.S. Application Data
(60) Provisional application No. 63/650,965, filed on May 23, 2024.

(51) Int. Cl. G06F 8/41

(52) U.S. Cl. CPC G06F 8/4435; G06F 8/433

(57) ABSTRACT

Methods and systems describe providing for simafication of machine computer code. The system received a computer program for evaluation and determining a plurality of occurrences of sets of instructions in the code of the computer program that will reproduce the same computed results when the code is executed. For each determined plurality of occurrences of the instructions the system computes the results of the instructions and the system generates a new set of instructions describing the computed results. The system updates the received computer by replacing the occurrences of the instructions in the code with the generated new set of instructions describing the computed results.

### CROSS-REFERENCE TO RELATED APPLICATIONS

This application relates to U.S. patent application Ser. No. 17/210,499, filed on Mar. 24, 2021, now issued U.S. Pat. No. 11,537,372 titled Generating Compilable Machine Code Programs from Dynamic Language Code. This application is a non-provisional application and claims priority the U.S. provisional application 63/650,965 filed on May 23, 2024.

### FIELD

The present invention relates generally to computer science, and more particularly, to methods and apparatuses for simafication of program code.

### SUMMARY

Methods and systems describe providing for simafication of machine computer code. The system received a computer program for evaluation and determining a plurality of occurrences of sets of instructions in the code of the computer program that will reproduce the same computed results when the code is executed. For each determined plurality of occurrences of the instructions the system: computes the results of the instructions and generates a new set of instructions describing the computed results. The system updates the received computer by replacing the occurrences of the instructions in the code with the generated new set of instructions describing the computed results.

In some embodiments, the system analyzes how a program performs instructions and determines that some parts of the program will always yield the same results. The system then proceeds to replace the original computer program instructions or code with the determined results.

In some embodiments, the simafication process searches instructions in the code of computer program for instances of instructions where the computer program obtains data or values external to the program (such as those commands that perform operations with regard to files or computer memory). The system will create as a slice the segment of code that performs these operations and execute this slice of code to obtain the results of the execution of the code. In some embodiments, the simafication process identifies code instructions where a constant value or values are used in the code. The instructions in the code are resolved in a manner to use the constant value and new code replaces the program code such that the number of instructions that are performed by the replacement code is less than the number of instructions of the original code.

The simafication process as described herein is applicable to processing dynamic, static, machine code and code that is executed at runtime (such as inside a java virtual machine that executes Java bytecode).

In some embodiments, the process will resolve dynamic code instructions that include references to files our other sources of data external to the computer program. For example, a computer program may access a configuration file, or website or some other data resource used by the computer program. The system may perform the simafication process and then obtain the data values from the external data source and rewrite the code instructions and include in the instructions that values of the data from the external data sources. So instead of the computer program having to perform operations to access and read data from the external sources, the rewritten code removes the read instructions and instead replaces the instructions with the referenced data itself in the rewritten code. The new rewritten code then does not have to perform the read commands to access the external data.

The appended claims may serve as a summary of this application.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 1C is a diagram illustrating an exemplary computer system that may execute instructions to perform some of the methods herein.

FIG. 2A is a flow chart illustrating an exemplary method that may be performed in some embodiments.

FIG. 2B is a flow chart illustrating additional steps that may be performed in accordance with some embodiments.

FIG. 3A is a diagram illustrating one example embodiment 300 of a generated super slice callgraph for a computer program, in accordance with some embodiments.

FIG. 3B is a diagram illustrating one example embodiment 320 of a generated slice for a static instruction, in accordance with some embodiments.

FIG. 3C is a diagram illustrating one example embodiment 300 of executing a compiled program, in accordance with some embodiments.

FIG. 4 is a flow chart illustrating an exemplary method that may be performed in some embodiments.

FIG. 5 is a flow chart illustrating an exemplary method that may be performed in some embodiments.

FIGS. 6A-6B are diagrams illustrating an exemplary callgraph for a portion of a computer program, in accordance with some embodiments.

FIG. 7 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

### I. Exemplary Environments

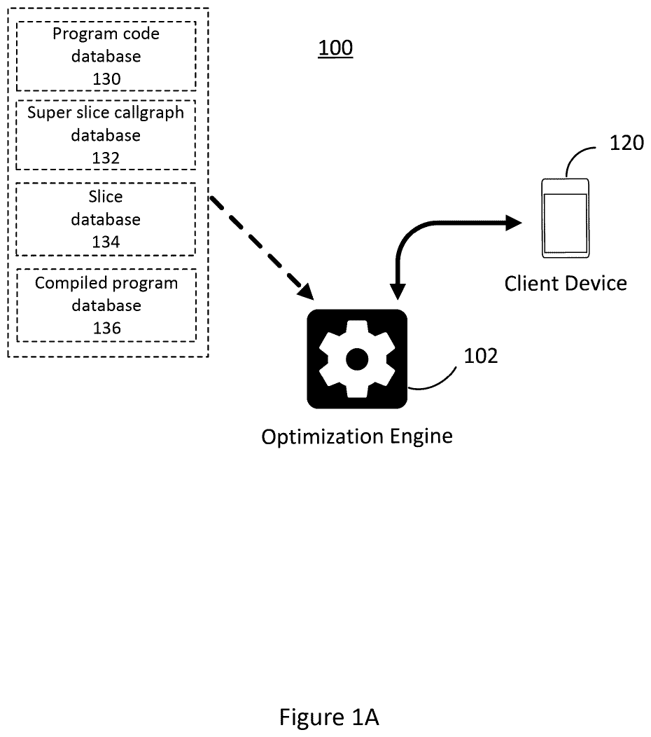

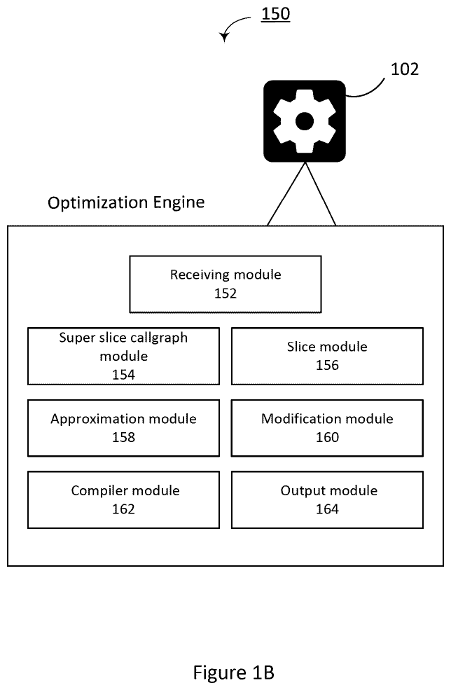

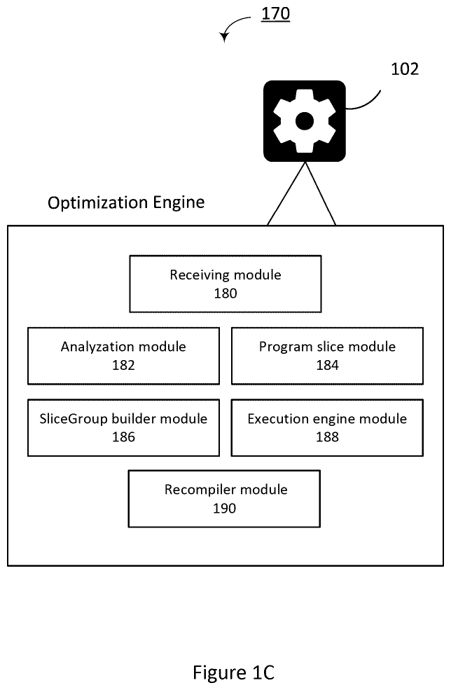

FIG. 1A is a diagram illustrating an exemplary environment in which some embodiments may operate. In the exemplary environment 100, a client device 120 is connected to an optimization engine 102. The optimization engine 102 is optionally connected to one or more optional database(s), including a program code database 130, super slice callgraph database 132, slice database 134, and/or compiled program database 136. One or more of the databases may be combined or split into multiple databases. The scanning device and client device in this environment may be computers.

The exemplary environment 100 is illustrated with only one client device and optimization engine for simplicity, though in practice there may be more or fewer client devices and/or optimization engines. In some embodiments, the client device and optimization engine may be part of the same computer or device.

In an embodiment, the optimization engine 102 may perform the method 200 or other method herein and, as a result, provide generation of a compilable machine code program from language code. In some embodiments, this may be accomplished via communication with the client device or other device(s) over a network between the client device 120 or other device(s) and an application server or some other network server. In some embodiments, the optimization engine 102 is an application hosted on a computer or similar device, or is itself a computer or similar device configured to host an application to perform some of the methods and embodiments herein.

Client device 120 is a device that sends and receives information to the optimization engine 102. In some embodiments, client device 120 is a computing device capable of hosting and executing one or more applications or other programs capable of sending and receiving information. In some embodiments, the client device 120 may be a computer desktop or laptop, mobile phone, virtual reality or augmented reality device, wearable, or any other suitable device capable of sending and receiving information. In some embodiments, the optimization engine 102 may be hosted in whole or in part as an application executed on the client device 120.

Optional database(s) including one or more of a program code database 130, super slice callgraph database 132, slice database 134, and/or compiled program database 136 function to store and/or maintain, respectively, code which is optimized by the optimization engine 102, super slice callgraphs generated or received as part of the optimization process, slices generated as part of the optimization process, and compiled programs generated from program code. The optional database(s) may also store and/or maintain any other suitable information for the optimization engine 102 to perform elements of the methods and systems herein. In some embodiments, the optional database(s) can be queried by one or more components of system 100 (e.g., by the optimization engine 102), and specific stored data in the database(s) can be retrieved.

FIG. 1B is a diagram illustrating an exemplary computer system 150 with software modules that may execute some of the functionality described herein.

Receiving module 152 functions to receive a computer program comprising code. In some embodiments, the computer program consists of code (e.g., source code, machine code or bytecode) received from the client device 120 or some other device or system. In some embodiments, the code is written in a dynamic language or machine executable code. A “dynamic language” is a programming language where the executable code is generated at runtime (i.e., during execution). As such, a programmer using a dynamic language can decide how a program is to be executed at runtime to generate executable code. In some embodiments, the dynamic language may be, e.g., Java, Python, Ruby, PHP, or any other dynamic programming language.

Super slice callgraph module 154 functions to generate one or more super slice callgraphs based on the received program. A super slice callgraph is a callgraph of function calls (e.g., all function calls within a given instruction) extended to include dependency relationships comprising variables and static variables within time constraints. The dependency relationships may include read→write dependency relationships. Generation of super slice callgraphs will be described in further detail below.

Slice module 156 functions to generate a set of slices for a given instruction. The slices are generated by slice module 156 based on a generated super slice callgraph for the instruction. A slice is generated for each of the function calls that are identified by super slice callgraph module 154.

Approximation module 158 functions to compile and approximate execution of each generated slice. In some embodiments, the approximation module 158 is a dynamic-compilation machine capable of executing slices.

Modification module 160 functions to update the computer program such that each of at least a subset of the instructions is replaced with machine code instructions based on the corresponding values. In some embodiments, the modification module 160 compiles the updated computer program. In some embodiments, the modification module 160 sends this compiled computer program on to one or more systems or devices, or presents it within a user interface of a client device. In some embodiments, cloud compilation is performed. Because compilation can take a significant amount of compute time, such compilation can potentially be much faster using techniques such as parallelism.

Compiler module 162 functions to compile the updated computer program. In some embodiments, the compiler is a static-compilation-based compiler or machine capable of compiling and approximating execution of the computer program based on machine code. In some embodiments, the compiler module 162 sends this compiled computer program on to one or more systems or devices, or presents it within a user interface of a client device. In some embodiments, cloud compilation is performed. Because compilation can take a significant amount of compute time, such compilation can potentially be much faster using techniques such as parallelism.

Output module 164 functions to send the updated computer program to one or more devices or systems. In some embodiments, output module 164 sends the updated computer program to client device 120, compiled program database 136, or some other element of the system. In some embodiments, output module 164 sends the updated computer program to one or more external devices via communication with one or more networks and/or servers. In some embodiments, output module 164 functions to display one or more output elements within a user interface of client device 120 or some other device or system. Displayed elements may include, for example, the optimized code within the updated computer program after modifications, information about the optimizations performed, one or more super slice callgraphs or sub-super slice callgraphs, an environment to perform further approximation of executions of the computer program, one or more metric (e.g., number of instructions in the computer program, number of instructions replaced with static instructions, number of total optimizations performed, estimated, approximated, or actual compilation and/or execution time), or any other suitable elements related to the systems and methods herein.

FIG. 1C is a diagram illustrating an exemplary computer system 170 with software modules that may execute some of the functionality described herein.

Receiving module 180 functions to receive a computer program comprising code. In some embodiments, the computer program consists of code (e.g., source code, machine code or bytecode) received from the client device 120 or some other device or system. In some embodiments, the code is written in a dynamic language. A “dynamic language” is a programming language where the executable code is generated at runtime (i.e. during execution). As such, a programmer using a dynamic language can decide how a program is to be executed at runtime to generate executable code. In some embodiments, the dynamic language may be, e.g., Java, Python, Ruby, PHP, or any other dynamic programming language.

Analyzation module 182 functions to compile and analyze the computer program. In some embodiments, the analyzation module 182 creates a versioned dependency graph (VDG).

Program slice module 184 functions to generate a set of slices based on the received program for a given instruction. A set of slices are extended to include dependency relationships comprising variables and static variables within time constraints.

SliceGroup builder module 186 functions to generate a set of slices based on the received program and handle method/function calls, static and instance variables. Static variables are variables initialized only once, at the start of execution. Instance variables are created when an object is instantiated, and may be accessible to all constructors, methods, or blocks in the class.

Execution engine module 188 functions to execute the generated slices from the program slice module 184 and SliceGroup builder module 186. The execution engine 188 executes the generated slices to capture values of the slices.

Recompiler module 190 functions to recompile slices that have been partially evaluated. Once the slices have been evaluated, code generated from the slices are replaced. Code generated from the recompiler module 190 may be stored in a metadata file for processing by the virtual machine (VM) or the operating system.

Reflection calling reflection is performed where an instruction depends on one other instruction. In some embodiments, the first instruction is resolved, generating a new binary and then a second instruction, up to n instructions. Through reflection, methods can be invoked at runtime as long as the name and parameter types of the method are known. In some embodiments a threshold is defined, breaking infinite recursive cycles.

Thread interference occurs when more than one thread, executing simultaneously, access the same piece of data. When multiple threads have access to the same data set, the data may be corrupted. The versioned dependency graph (VDG) and super slice callgraph may indicate the threadbility of a group or list of instructions. The threading strategy derived from the versioned dependency graph enables parallelization of one or more disparate blocks of code.

Escape analysis is a technique that the analyzation module 182 may use to determine where in the program a pointer can be accessed. Escape analysis is performed through a combination of the versioned dependency graph (VDG) and super slice callgraph exploration to detect dependency relationships occurring simultaneously in more than one thread.

The above modules and their functions will be described in further detail in relation to an exemplary method below.

### II. Exemplary Method

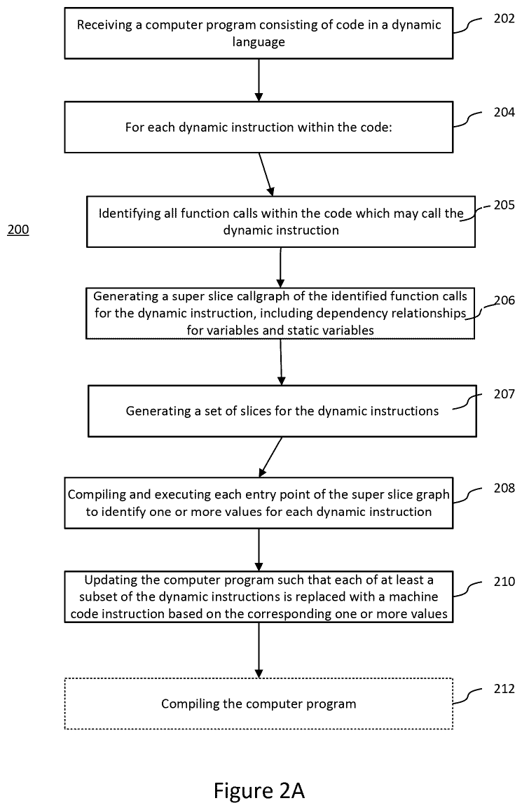

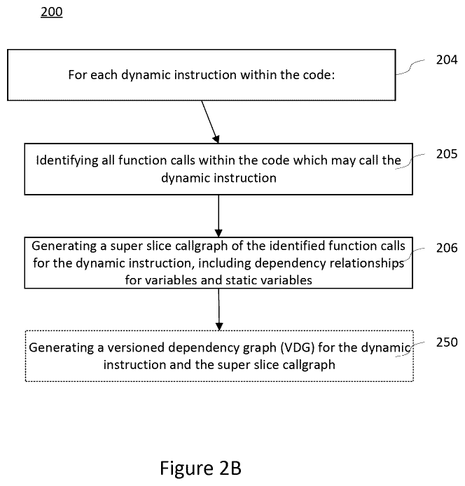

FIG. 2A is a flow chart illustrating an exemplary method that may be performed in some embodiments.

At step 202, the system receives a computer program comprising code in a dynamic language. In some embodiments, a client device 120 sends a computer program in code form to one or more devices or systems configured to receive the computer program. In some embodiments, a user selects the computer program based on a prompt or request for the computer program within a user interface of the client device. Upon selecting the program, the computer program is sent to the optimization engine 102, which may be part of the client device 120 or part of some other device or system. In some embodiments, the computer program consists of code in a dynamic language, such as Python or any other suitable dynamic language. For example, “reflection” is a dynamic language feature within Java. The Java Reflection Application Programming Interface (API) allows programmers to dynamically inspect and interact with otherwise static language concepts such as classes, fields and methods, in order to, e.g., dynamically instantiate objects, set fields, invoke methods, and perform other suitable tasks within programming languages. In some examples, therefore, a user may choose an option to send a Java program containing dynamic reflection instructions to one or more elements of the system via a user interface on a client device. In some embodiments, upon the system receiving the program, a verification step is performed in order to verify that the program submitted contains one or more instructions.

At step 204, a number of following steps, particularly steps 205, 206, and 207, are performed for each instruction within the code of the received computer program. In some embodiments, the system locates and/or identifies all instructions within the code, then carries out the aforementioned steps for each of the instructions. In some embodiments, the system steps through each line of the program, and when it identifies an instruction within the program, it carries out the aforementioned steps. In various embodiments, an instruction can be identified by the system in a number of ways. For example, some instructions can be identified by the system based on a predefined list of instructions. Other instructions can be identified based on whether a returned value or state is predictable or determinable before the program is executed.

An example of an instruction within code is illustrated below:

def succ(y):
return lambda x:
x+y add5 =
succ(5)
print add5(3)
... 8
add1 = succ(1)
print add1(3)
... 4

In the preceding code, “succ(y)” is a dynamic function which defines a way to build functions. Once defined, add5 can be defined using the dynamic function succ(y) by declaring that add5=succ(5). The call add5(3) thus returns 8 based on defining add5 through dynamic function succ(y).

At step 205, the system identifies all function calls within the code which may call the instruction. In terms of machine code, most instructions within a dynamic language program are called via function calls. In some embodiments, the system identifies function calls based on one or more predefined criteria. In some embodiments, the system identifies function calls by parsing based on the programming language.

At step 206, the system generates a super slice callgraph for the instruction. A super slice callgraph is a callgraph of function calls (e.g., all function calls for a given instruction) extended to include dependency relationships, for instance variables and static variables within time constraints. The dependency relationships may include read→write dependency relationships.

In some embodiments, super slice callgraphs represent the control flow of identified function calls for a given instruction, as well as the control flow of dependency relationships for instance variables and static variables within the given instruction, within time constraints. In some embodiments, the control flow of these dependency relationships may comprise or illustrate read→write dependencies, how static variables or instance variables of a class are generated, or how data is stored within static variables or instance variables. In some embodiments, this accounts for call methods, updating static and instance variables, and/or updating field values of classes. In some embodiments, super slice callgraph module 154 generates the super slice callgraphs by first identifying all function calls within the received code, which may call the instruction. A super slice callgraph is then generated for all functions calls for that instruction as well as all dependency relationships for instance variables and static variables within time constraints.

In some embodiments, each node of the super slice callgraph represents a program path where, e.g., the identified function call may call the instruction and may depend on one or more static and/or instance variables which are created or updated within given time constraints. In this way, formal logic is used to build a control flow of the program and determine all possible paths.

In some embodiments, the super slice callgraphs may be considered “sub super slice callgraphs” of a larger overarching super slice callgraph which represents the program as a whole. In some embodiments, the overarching super slice callgraph represents a control flow of the program starting with a main path, then branching based on all methods being called and all functions being called (as well as all dependency relationships of static and instance variables being represented), down to all functions calling functions, until all path possibilities are exhausted. The sub super slice callgraphs are subsets of the overarching super slice callgraphs. Each sub super slice callgraph takes one method or function, represents the control flow of all the methods or functions calling that method or function, and so on until the root program ends. In some instances and embodiments, reflection calls another reflection, which will be further discussed below.

At step 207, the system generates a set of slices for a given instruction. In some embodiments, a certain N number of slices will be identified at the end of the control flow of the program, which is equal to the number of paths identified between the root of the program to the final leaves of each of the super slice callgraphs. Each slice represents one of the paths for the given instruction. In some embodiments, the system generates each slice by extracting the portion of the program which is represented by a particular generated super slice callgraph for an instruction and iterating until all the portions of the programs represented in the super slice callgraphs are extracted. As such, the system extracts slices which collectively yield all possible states, configurations, or values for the instructions. In some embodiments, extracting the slice involves generating a versioned dependency graph (VDG) for the instruction. The VDG represents a dependency path base. The system extracts one or more static instructions from the instruction based on the dependency path as represented by the VDG. Alternatively to generating a VDG, any other suitable method may be used which extracts the slice based on dependency paths for instructions. In some embodiments, extracting the static instructions involves resolving one or more pointers within the instruction; modifying one or more signatures of the instructions such that only primitive data types are passed into the instruction; replacing one or more dynamic libraries with one or more static libraries; and replacing one or more static variables within the instruction with values.

Each of the slices will have only one possible resolution or “state”, although the slices can share a state. Each instruction has one or more possible states. For example, the “succ” instruction above has two possible states: 5 and 1. There are a finite number of states as long as the system determines the states to be enumerable. An instruction must have a state attached to it to be usable by the main program. In addition, an instruction with a state attached to it will be compilable in machine code. For many instructions, the system will be able to enumerate all the possible states, i.e., know what values are returned by the branching paths or slices. Dynamic code is limited to a number of potential cases; for example, the code of a dynamic language program can have, e.g., less than 1,024 possible states. In some cases, the instructions are such that the number of states is unenumerable. By executing a slice, in some situations, it is possible to determine a state that the slice ends up in, represented as the last value which will be generated at the end of a slice. By executing and determining such states, it is possible to optimize each slice. The preceding description of programs, slices, and states will inform the following steps in relation to optimizing slices.

In some embodiments, the system synthesizes each slice based on following the control flow path in the generated VDG. In some embodiments, this process includes the system selecting all the call stacks and executing them to generate a new program out of them. In some embodiments, the system synthesizes the slice in order to rebuild the offsets of all addresses, as the offsets have changed. In some embodiments, the system synthesizes the slice such that the fewest number of instructions possible are changed. In some embodiments in which slices are synthesized, executing the slices in step 208 involves an additional step of executing all synthesized slices in the same execution pass.

At step 208, the system compiles and executes each entry point of the super slice graph to identify one or more values for each instruction. In some embodiments, the system performs this step by compiling and executing each of the generated slices for the instruction and receiving one or more values (i.e., resulting states) at the end of each executed slice. In some embodiments, the slices are compiled and approximately executed using a machine (e.g., a virtual machine) capable of compiling and approximating execution of dynamic language code. In some embodiments, the slices are compiled and executed or approximately executed using a real computer or a virtual machine (VM). In instances where approximate execution is performed, the instruction is not executed, but rather than approximation of the instruction which involves less data processing. This is possible because the system only executes the instructions to generate results based on some relevant properties for that slice. In some embodiments, a compiler using one or more optimization techniques to replace the instruction with a static instruction is employed. In some embodiments, compiling and approximating execution of the slices is performed with a dynamic-compilation-based machine, while compiling the computer program is performed with a static-compilation-based machine.

In some embodiments, upon execution of the slices, two results are possible. A first result is the state(s) of the instruction. A second result is notification of a crash or unresponsive program due to a delay in execution or taking too long to execute. In some embodiments, this may be the result of an instruction failure to execute or exceeding a time threshold for execution. If the second result occurs, the system determines that the instruction is not “compilable” due to the number of states either being too large or enumerable such that optimization and compilation are not possible or desirable within the boundaries of the system. In some embodiments, determining that the instructions are not compilable or optimizable is based on the number of states returning values not being estimable or quantifiable beyond a predefined threshold. In an example case where the input of a function depends on an external value such as a user-submitted string value in a text field, and the input from the user is necessary to generate the function, it is impossible for the system to predict what will happen and thereby enumerate the states possible. In this instance, determining the number of states is an undecidable problem. In most situations, such “unsolvable” cases are relatively rare compared to the solvable cases. The result is that the program cannot be optimized, even though the program as a whole will still work as expected. Otherwise, determining all the reachable states of an instruction will allow the system to compile it to machine code for a specific architecture.

For example, the slices for the “succ” instruction above can be executed in a python interpreter. The states are determined to be 1 and 5. Compiling the program, the system creates the two static functions add (1) and add (5), directly removing the lambda calls and the succ dynamic function. The resulting substitution for the code in the example above would be:

add1:
return x
+ 1
add5:
return x
+ 5

At step 210, the system updates the computer program such that each of at least a subset of the instructions is replaced with machine code instructions based on the corresponding values. In some embodiments, an instruction is replaced with its one or more values in the initial slice using well known compiler techniques. Techniques which can be used can include, for example, Just-In-Time (JIT) techniques to keep lines of machine code in memory and reuse them; interpreter techniques to general lines of machine code for each line of interpreted program; JIT tracing techniques wherein JIT is optimized with better performance based on current program use; or any other suitable runtime optimizations. In some embodiments, one or more reflection instructions are replaced with static instructions. In some embodiments, during the execution of the slices in step 208, new information is received from the system which is used to execute the next instruction. This results in optimizations while updating the computer program. In some embodiments, simple optimizations can be achieved by substituting static instructions related to data structures and other elements of object-oriented programming. For example, a.getName( ) would get converted into a String if “a” is always of the String type during runtime. In some embodiments, the computer program includes self-modifying code, such that upon compilation and execution, the code is configured to modify itself to be optimized further. Such self-modification techniques can include, e.g., one or more of the aforementioned optimization techniques.

At step 212, in some embodiments, the system compiles the computer program. In some embodiments, during the compilation, the compiler techniques described in step 210 are applied. In some embodiments, the updated computer program is stored in one or more databases, e.g., the compiled program database 136. In some embodiments, upon compiling the program, the updated computer program is sent to one or more devices or systems, such as, e.g., the client device 120.

In some embodiments, the system displays one or more output elements within a user interface of client device 120 or some other device or system. Displayed elements may include, for example, the optimized code within the computer program after modifications, information about the optimizations performed, one or more super slice callgraphs or sub-super slice callgraphs, an environment to perform further approximation of executions of the computer program, one or more metrics (e.g., number of instructions in the computer program, number of instructions replaced with static instructions, number of total optimizations performed, estimated, approximated, or actual compilation and/or execution time), or any other suitable elements related to the systems and methods herein.

FIG. 2B is a flow chart illustrating additional steps that may be performed in accordance with some embodiments. Steps 204, 205, and 206 are as described in FIG. 2A. During generation of the slice at Step 206, in some embodiments, additional steps may be performed. At optional step 250, the system generates a versioned dependency graph (VDG) for the instruction and the super slice callgraph, as described in FIG. 2A above.

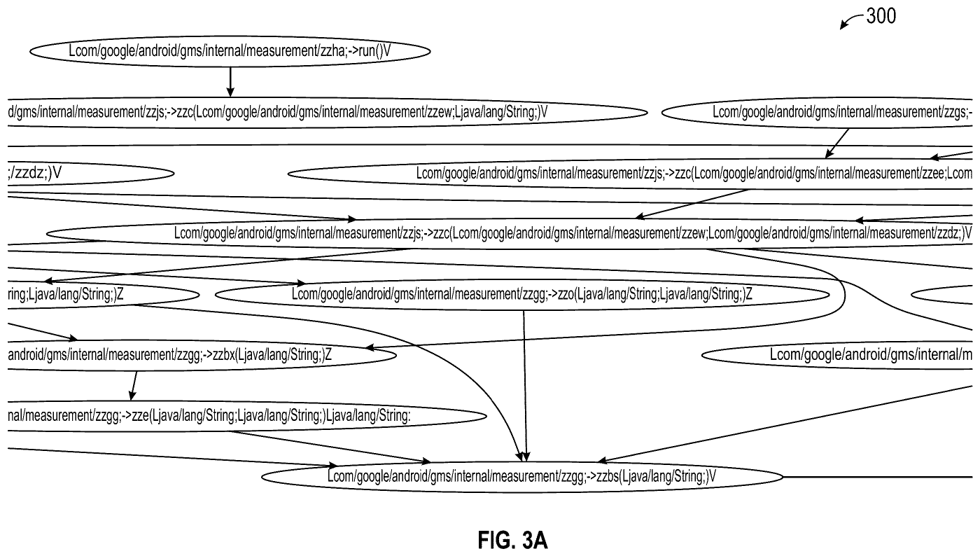

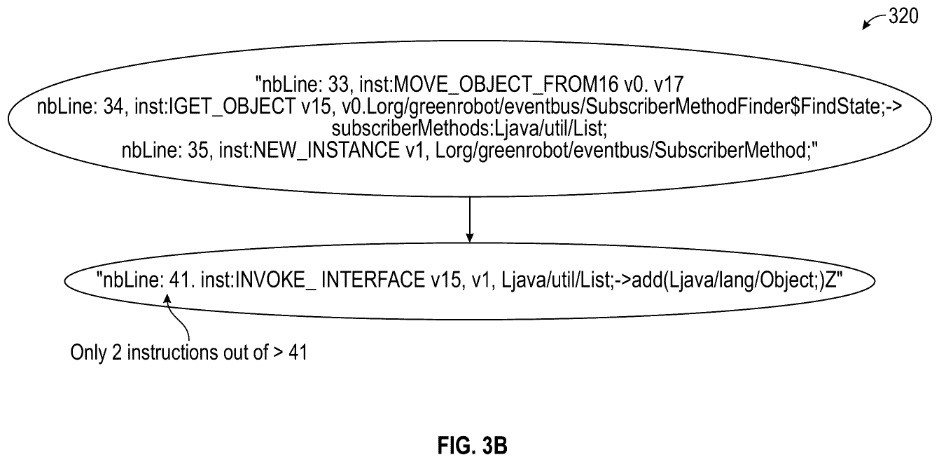

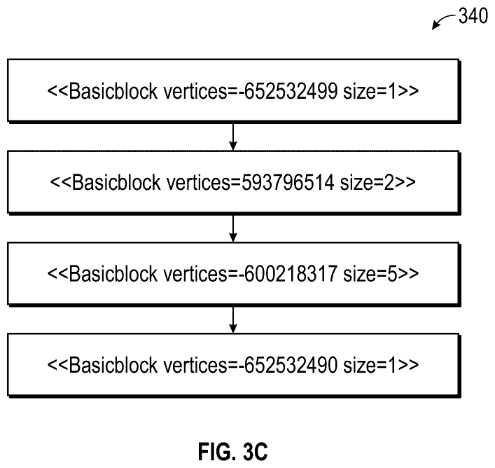

FIG. 3A is a diagram illustrating one example embodiment 300 of a generated super slice callgraph for a computer program, in accordance with some embodiments. The diagram shows a subset of a super slice callgraph which is generated for the computer program, in order to illustrate the control flow of the computer program along multiple possible branching paths. Each branch of the super slice callgraph represents one method, and each of the branching paths represents a method which is calling that method. These paths continue until the “root” of the program, i.e., no more methods are being called and the existing methods have terminated. The example illustrates that a typical computer program, especially one with instructions, can become very complicated quickly. Typically, such super slice callgraphs can contain thousands or even millions of nodes representing function calls and possible branching paths.

FIG. 3B is a diagram illustrating one example embodiment 320 of a generated slice for a static instruction, in accordance with some embodiments. The slice generated in the example returns the reflection value upon execution, or approximated execution, of the slice. The slice includes staticized instructions which the system has inserted as a replacement for one or more of the instruction(s) which were illustrated in FIG. 3A. The super slice callgraph gives you all possible values of the seed (i.e. the target instruction) of the larger program, with staticized instructions to be substituted. If the system executes a specific instruction, it must go to a single program and execute the method calling that program. Typically in a dynamic program, the process becomes more complicated, since most of the instructions of the method have nothing to do with the instruction the system is executing. If static instructions are substituted within a slice, however, then there is no need to execute methods from the rest of the program, which simplifies the program significantly. Thus, only 2 instructions out of over 41 need to be called in this slice, allowing for significant optimizations of the code.

FIG. 3C is a diagram illustrating one example embodiment 340 of executing a compiled program, in accordance with some embodiments. The diagram illustrates a debug system during runtime execution of a compiled program at the end of the steps from FIG. 2A. In the compiled and optimized program, only a few instructions remain, and each instruction is much simpler than the previous instruction. A given pointer to a function will typically perform the same process most of the time from one execution to the next, for example, and a given variable will typically not change its underlying data structure most of the time. For example, it is very uncommon for an integer to be converted into a string, and the cases in which it will happen can be detected. Therefore, the program is simplified and optimized in this way. Thus, as illustrated, the current state of the Basic Blocks in terms of vertices and size changes in a predictable and static way in the compiled program, leading to a more efficient and optimized program which is capable of being compiled and executed much faster than the equivalent dynamic program would be.

### Simafication of Computer Program Code

In some embodiments, the system determines a series or set of instructions that when executed yield the same results. The system may evaluate various code in different dynamic programming languages, interpreted programming languages, machine code or object code to determine which instruction sets yield the same results.

In some embodiments, the system executes loads into a callgraph the instructions of the program. The system executes some or all portions of sets of instructions to determine the results generated by the instruction sets. In some embodiments, the instruction sets of the evaluated by the system that are determined to produce the same results, are replaced with instructions for the computed results. Replacement of the original instructions sets, increases the computational speed of the program in that it no longer has to perform the original instructions that perform computations. Some of types of instructions that may be replaced include, calculation of numeric values, instructions for combining or using strings or characters, network calls to other servers, services, application or resources, use of file system commands or memory commands to access data or information external to the program.

In some embodiments, the system identifies a set of instructions to be replaced and replaces those instructions with instructions written in the same programming language (such as javascript to javascript). In other embodiments, the system identifies a set of instructions to be replaced and replace those instructions with a call to an external program. For example, that system generate a set of instructions that provides the results of the processing of the instructions in the input programming language that are to be replace. The system may compile the replacement instructions into object or machine code, and the original instructions in the input program may be replaced with replacement code with call to the object or machine code file. A new replacement program is generated with the replacement code. When the new replacement program is performed, the object or machine code may be loaded into memory, and is referenced by the replacement program code to perform the replacement instructions.

In some embodiments, the system tracks the instruction sets of the original program that is replacement with the replacement code. The system determines a number of instructions replaced and may generate a report, via a user interface, describing a performance increase score based on the number of instructions of the original program that have been replace.

In some embodiments, the system tracks the amount of time and/or computations that were removed from the original program due to time consuming instructions for network calls to other computing devices, services and/or applications or time-consuming instructions related to performing disk or file system read operations.

In some embodiments, the generated replacement program is particularly suited for server-based programs that perform calls to other networked based computing devices, services and/or applications. Also, the generated replacement program is particularly suited for server-based programs that perform read operations from file systems to obtain configuration information. Typically, configuration files used in a server-based program do not change. In some embodiments, the system may perform a versioning process to evaluate whether a configuration file referenced by the original program has changed. In such instances, the system may be configured to automatically perform a regeneration of the original program so as to obtain new changes to data that may have been made to a configuration file.

In some embodiments, the generated replacement program includes pointers to memory where the computation results are stored. For example, the system may evaluate an input program code to determine instructions to be replaced. The system may identify that one or more sets or series of instructions produce the same results. The results for example, may be one or more numeric values, strings, characters, or other data types. The system may replacement code to generate a table or other data structure with the results such that the results are loaded into memory when the replacement program is executed. In this example, the system generates code to refer to the data in the table using programming constructs such as pointer references, a reference to a variable and/or a reference to an array construct.

In some embodiments, the system determines the set of instructions from the original program by executing portions of instructions from the original program to identify those instructions that may be replaced. In some embodiments, the determined set of instructions include a sequential series that are performed by the original program that when performed allows computes the same result. In some embodiments, the determined set of instructions include a sequential series that are performed by the original program that when performed computes a limited set of results (such as two different result, three different results, four different results, etc.). In this example, this system may execute a set of instructions for x number of times and determine whether any values of the set of instructions are repeated. The system may determine that if none of the executed iterations of the same set of instructions have the same computed results, the system may identify that set of instructions as not being able to be replace. Where the set of instructions of the original program when executed always produce the same result, then the code of the original program may be simplified with replacement code (e.g., a more efficient set of code the does not have to perform computations to generate the result, rather the instructions of the original program may be replaced with code that just refers to the values of the computed results.

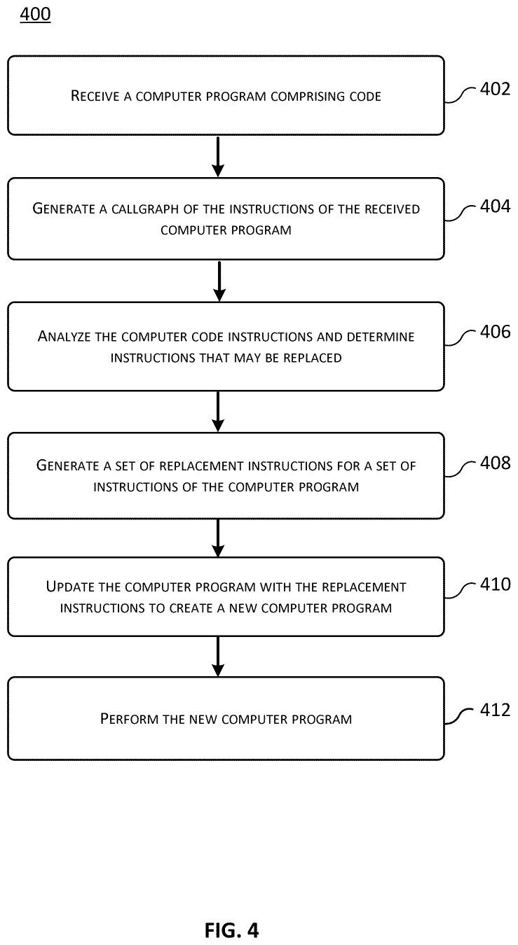

FIG. 4 is a flow chart illustrating an exemplary method 400 that may be performed in some embodiments. This method describes a process of simafication of a computer program. The system evaluates the instructions, and determines if the computer instructions can be replaced with different code, and then generates the replacement code. The system analyzes how a program performs instructions and determines that some parts of the program will always yield the same results. The system then proceeds to replace the original computer program instructions or code with replacement code representing the determined results. In contrast, the system may analyze how a program performs instructions and determines that portions of instructions do not always yield the same results. In this case, the system does not replace these instructions, but leaves the instructions the same or intact when generating the replacement program code.

At step 402, the system receives a computer program comprising code. The code may be in machine readable or human readable form. In some embodiments, a client device 120 sends a computer program in code form to one or more devices or systems configured to receive the computer program. In some embodiments, a user selects the computer program based on a prompt or request for the computer program within a user interface of the client device. Upon selecting the program, the computer program is sent to the optimization engine 102, which may be part of the client device 120 or part of some other device or system.

At step 404, the system generates a callgraph of the instructions of the received computer program. The callgraph describes a graph of the relationship of instructions of code of the received computer program. The system may execute the received computer program and generate the call graph and resolve assignment of data to variable in the computer program. In some instances, the system may determine that a variable may have a set of possible values. In other words, the system may determine that a variable has one or more possible values.

In some embodiments, to obtain all of the possible values for a variable of the computer program. The system repeatedly executes the received computer program to identify the values for a variable. For example, the system may execute a computer program about 3-10 times, and for each execution of the computer program, the system may store an identified value of for a variable. Where the value of the variable is different for each execution pass of the computer program, then the system determines that value is likely different each time the computer program executers and would not be able to replace a sequence of instructions of the computer program with instructions of a computed result. Where the value of the variable is the same for each execution of the computer program, then the system determines that the instructions may be replaced with a computed result. Also, during multiple executions of the computer program, multiple but repeated values may be determined. In this situation, the system may replace the instructions of the computer program with instructions for a selection of one of the repeated values.

At step 406, the system analyses the received computer code instructions and determines sections of the computer code that may be replaced. The system determines a plurality of occurrences of sets of instructions in the code. For example, the system analyzes a set or series of instructions of code here the code, when executed or performed, produces the same results.

In some embodiments, the system determines if a series of instructions of the received computer code include arithmetic operations applied to constant values in the computer code. The system may perform the arithmetic operations as to the constant values and determine (i.e., compute) a value for the result of these operations. The original computer code of the arithmetic operations applied to the constant values may be replaced with code with the determined value for the results of the operations. For interpreted code, some arithmetic operators would include (‘+’ for addition, ‘−’ for subtraction, ‘*’ for multiplication, ‘**’ for exponentiation, ‘/’ for division, ‘%’ for modulus (remainder), for ‘++’ for increment of a value, and ‘−−’ for decrement of a value.

In some embodiments, the system instruments and executes the slice of the code of the set of instructions. The segments of code may be stored in memory, a database or other storage devices for tracking and management of the code.

In step 408, the system generates a new set of replacement instructions that includes code describing the computed results. The particular set of code for the identified set of instructions may be run as it is by building a slice.

In step 410, the system updates the computer program to generate a new version of the computer program with the new set of replacement instructions.

In step 412, the new version of the computer program is executed with the new set of replacement instructions. As the original code includes instructions that may perform computations and/or retrieve data external to the computer program, the replacement of the program code with the computed results has the effect of increase the computer program perform, and in some situations quite significantly.

In some embodiments, the system determines if a series of instructions includes operations using values, such as numerical values, string values, character values, etc. that are obtained from a source external to the computer program, such as values obtained from a files system or from a computer memory. For example, many programs will retrieve one or more values from a configuration file using instructions to open and retrieve a value from the configuration file. For example, a name of a user may be stored in a configuration file and retrieved each time the program is executed. The simafication process searches the computer program for instances of instructions where the computer program obtains data or values external to the program (such as those commands that perform operations with regard to files or computer memory). The system will create as a slice the segment of code that performs these operations and execute this slice of code to obtain the results of the execution of the code. In this example, where data is obtained from an external file. In this example, the system will generate a new set of instructions with the computed result and replace the original instruction set that obtained the data from the file system. The new version of the computer program would insert into the code the string of name of a user. This replacement with the string value into the code would effectively speed up the performance of the computer program since it would no longer have to perform a file system read operation.

In some embodiments, the system determines the path of where an external file is accessed. For example, the system evaluates the code to determine whether an external file call is to the directory of where a computer program is executed or if s sub path or subdirectory is referred to obtain a file the retrieve data for variables of the computer program. Where the path is the same path as the computer program execution or a sub path, then the system may use the values found in read file and generate replacement instructions for the computed values. In this case, the read instructions of the original computer program would be replaced. In those situations, where a file is referenced outside of the computer program current path or a sub path, then the system may not resolve the values obtain from those files.

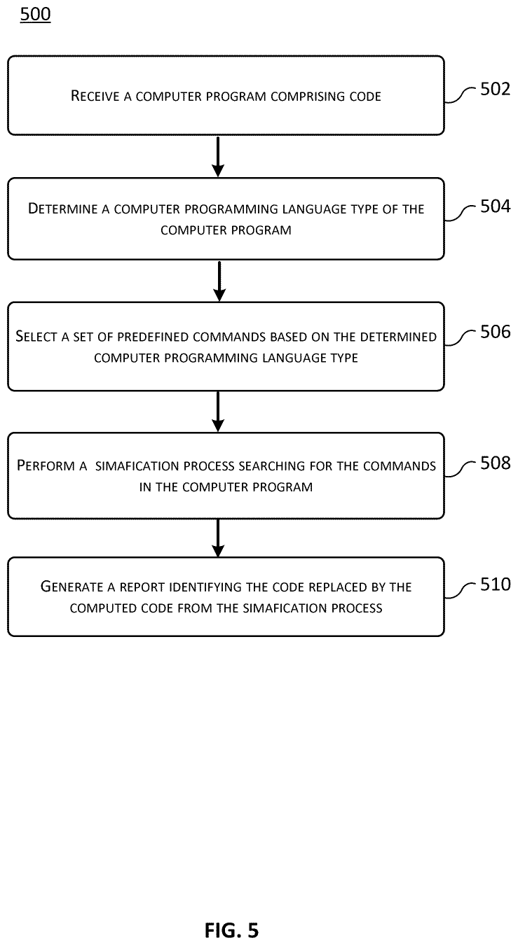

FIG. 5 is a flow chart illustrating an exemplary method 500 that may be performed in some embodiments. The system may receive a computer program and determine a set of commands for evaluation and replace in the computer program.

In step 502, the system receives a computer program comprising code.

In step 504, determine a computer programming language type of the computer program. In some embodiments, the system may evaluate different computer programs in different code languages. For example, the system may evaluate machine code, Python code, Java code, Ruby code, JavaScript code, C code, C++ code, etc. This listing is meant to be illustrative, and not limiting.

In some embodiments, the system may be configured to identify the type of language of the received computer program. For example, the received computer program may be an executable file in machine code. In another example, the received computer program may be interpreted code, such as a computer program written in JavaScript. For each type of language, the system may use a predetermined set of commands specific to the computer program language type to search the code for commands or instructions in the computer program that are suitable for replacement.

For example, the system may identify that a received program is of a JavaScript type, and may evaluate the code for a predetermined set of commands specific to JavaScript, such as FileReader( ) (that would indicate a likely command in JavaScript to obtain data from a file on a file system).

In step 506, the system selects a set of predefined commands based on the determined computer programming language type. For example, the system may identify that the received program is of a Python code type. Here the system evaluate the computer program code for a predetermined set of commands specific to Python code, such as an open (filename) command that indicates a likely read from a file on the file system.

The system may be configured to automatically evaluate the type of code the computer program is written in and based on the type of code evaluate the instructions of the code for a predefined set of commands specific to the code type. The system would evaluate the code for the occurrence of the particular predefined set of commands and determine whether the commands may be computed to generate a result. The generated result would replace the set of instructions that were used to generate the result.

In some embodiments, the system may identify the type of code of the computer program by the file type of the computer program, such as .py for Python Script, .js for JavaScript, .cs for C# source file or .exe for a machine code program. The example of code file types is meant to be illustrative and not limiting. Based on the particular file type of the computer program, then the system may use the predefined set of commands specific for the code type to evaluate the received computer program for instructions that may be replaced.

In some embodiments, the system may evaluate the code syntax and commands of the computer program to determine a code type. Some commands are unique to a computer programming language. The system may evaluate the code to identify if any unique commands occur in the computer program. Where the system identifies a unique command of a particular computer program, then identify the code type. Based on the code type, then the system may use the predefined set of commands specific for the code type to evaluate the received computer program for instructions that may be replaced.

In step 508, the system performs a simafication process as described herein. The system searches for the occurrence in the received computer program of the commands in the predefined list of commands for the respective computer programming language type.

In step 510, after performing the simafication process, the system generates a report listing the plurality of occurrences of sets of instructions and the associated replacement instructions for the computed results. The system may track the set of instructions with the set of replacement instructions for the computed results. The system generates a report identifying the particular instructions from the received computer program that have been replaced in the new generated program. In some situations, the replaced code may not be desirable, and a user may revise the generated program to revert changes to the code made by the simafication process. For example, the system may display, via a user interface, the code for the newly generated. The user interface may display and/or highlight the new code and the replaced code in proximity to one another. The user interface may include functionality to allow the user the revert the new code back to the original code, such as using a revert button or other user interface controls that move through each code segment and allowing the user to select a revert button or use some other input. A new program (with reversions selected by the user) then may be generated.

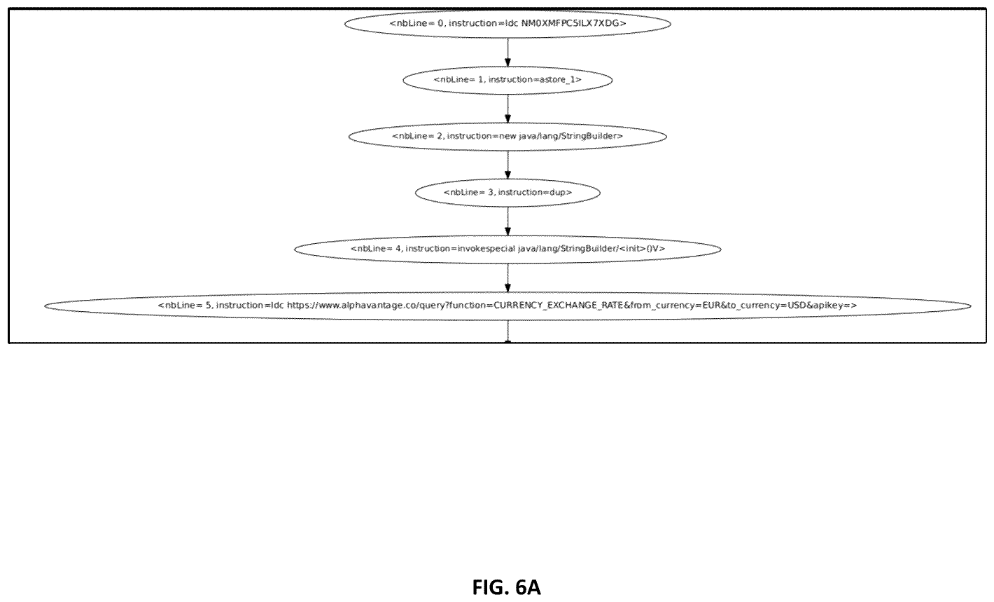

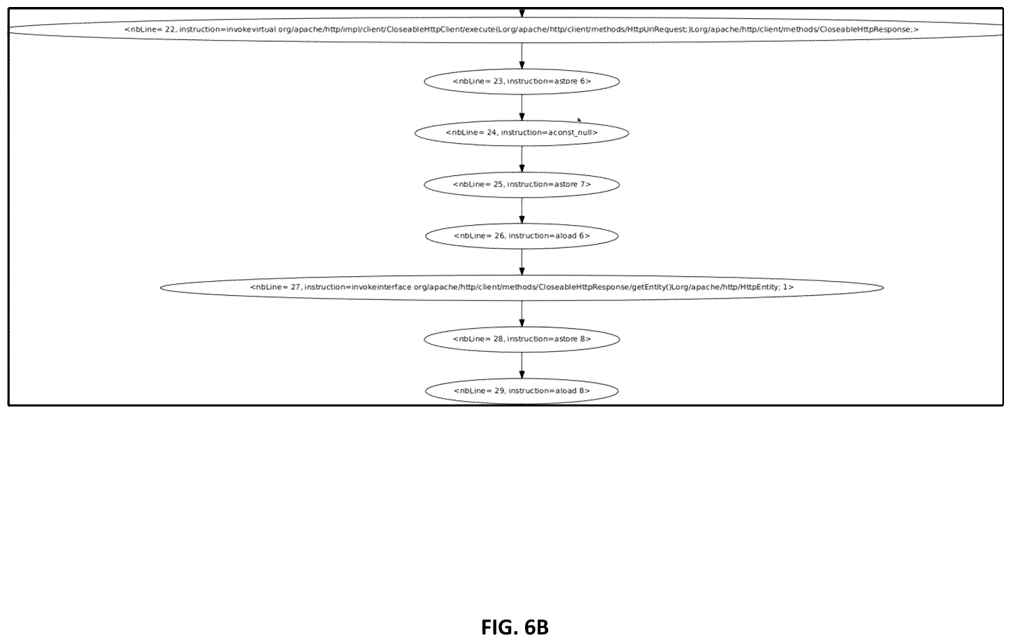

FIGS. 6A-6B are diagrams illustrating an exemplary callgraph for portions of a computer program, in accordance with some embodiments. The exemplary callgraph depicts roots of the graph and instructions performed by a portion of an exemplary computer program. The callgraph represents symbolic execution of the instructions. Each of the nodes of the graph is evaluated to determine whether the instructions may be performed. Some of the instructions may be dynamic in nature without the possibility of computing a result. Other instructions may be dynamic in nature but a result may be computed.

Referring to FIG. 6A, the system evaluates the instructions, and determines that code for the assignment of the constant value, that is latter used in the process may be replaced with instructions where the later instructions use the value, thereby remove the assignment of the constant value to the variable.

Referring to FIG. 6B, the system evaluates the instructions, but in this example, but instructions in this code segment may not be simafied due to the nature of the external http call with the retrieve result likely changing each time the external http call is made. In this case, performance of the code segment would not always yield the same results. In this example, the system evaluated code for possible replacement, but determine that the results would not be the same each time the computer program was executed, and the would not replace the set of instructions.

Below is a machine code example illustrating the simafication process:

```
# ====== Helper routines ======
printNewline:
  la a0, newline
  li a7, 4
  ecall
  jr x1
cycleElapsed:
  jal printNewline
  li a7, 31
  ecall
  li a7, 1 # Argument ‘4’ for ecall instructs ecall to print to console
  ecall
# This example demonstrates how strings, integers, chars and floating point
# values may be printed to the console
.data
str: .string “A string”
newline: .string “\n”
delimiter: .string “,”
.text
# ------ String printing ---------
  la a0, str # Load the address of the string, placed in the static data segment
  li a7, 4 # Argument ‘4’ for ecall instructs ecall to print to console
  ecall
  jal printNewline
# ------ Integer printing ---------
# Print numbers in the range [−10:10]
  li a0, −10
  li a1, 10
  li a2, 1
  jal loopPrint
  jal printNewline
# -------- Float printing ----------
# Print an approximation of Pi (3.14159265359)
  li a0, 0x40490FDB
  li a7, 2
  ecall
  jal printNewline
# ------ ASCII character printing ---------
# Print ASCII characters in the range [33:53]
  li a0, 33
  li a1, 53
  li a2, 11
  jal loopPrint
  # Finish execution
  jal exit
# ====== Helper routines ======
printNewline:
  la a0, newline
  li a7, 4
  ecall
  jr x1
# --- LoopPrint ---
# Loops in the range [a0;a1] and prints the loop invariant to console
# a0: range start
# a1: range stop
# a2: print method (ecall argument)
loopPrint:
  mv t0 a0
  mv t1 a1
loop:
  # Print value in a0 as specified by argument a2
  mv a0 t0
  mv a7 a2
  ecall
  # Print a delimiter between the numbers
  li a7, 4
  la a0, delimiter
  ecall
  # Increment
  addi t0, t0, 1
  ble t0, t1, loop
  jr x1
exit:
  jal printNewline
  li a7, 31
  ecall
  li a7, 1 # Argument ‘4’ for ecall instructs ecall to print to console
  ecall
  # Exit program
  li a7, 10
  Ecall
=> 426 cycles!
Becomes:
# This example demonstrates how strings, integers, chars and floating point
# values may be printed to the console
.data
str: .string “A string\n −10, −9, −8, −7, −6, −5, −4, −3, −2, −1, 0, 1, 2, 3, 4, 5, 6, 7, 8, 9,
10, \n 3.14159\n ! , \n”
.text
# ------ String printing ---------
  la a0, str # Load the address of the string, placed in the static data segment
  li a7, 4 # Argument ‘4’ for ecall instructs ecall to print to console
  ecall
  li a7, 31
  ecall
  li a7, 1 # Argument ‘4’ for ecall instructs ecall to print to console
  ecall
  # Exit program
  li a7, 10
  ecall
=> 5 cycles!
```

In this example, the increased processing speed up is 85 times.

In some embodiments, the simafication process analyzes code instructions and determines whether or not the code instructions can be simafied. For example, the system will analyze a line of code to determine whether the instructions can be resolved in a way that the instructions can be written to simplify the instructions to resolve variables, data (such constant values) that are used in the code instructions. If the code can be simafied, then the system generates new code instructions for the analyzed code instructions. In other words, the system generates new more efficient code, so that when the computer program is run, the number of instructions are reduced.

In some embodiments, the system determines whether the processed code instructions cause computational side effects to other portions of the computer program. A computational side effect may include changing the value of a variable, writing some data to local storage or memory. For example, code instructions may cause a computation side effect when a portion of the code instructions change a variable outside the scope of the code instructions. In another example, code instructions may cause a computation side effect where a function of the instructions change a non-local state or when the output is not deterministic. The simafication process evaluates codes instructions to determine whether the code instructions cause a computational side effect. In some embodiments, where the system determines that the code instructions would cause computational side effect, then the system does not simafy those code instructions. In other words, those code instructions would not be optimized and would be executed or run in their original form. In some embodiments, the simafication process performs a multiple-phase analysis of the code instructions. For example, the computer program may have multiple code instructions where a first occurring set of the instructions must be simafied. When the first occurring set of instructions is simafied, then the system restarts the process using the simafied first occurring set of instructions. The new generated simafied code then is executed, and then a second subsequent occurring set of instructions is then simafied. When the second subsequent occurring set of instructions is simafied the then system restarts the process using now the first simafied set of instructions and the second simafied set of instructions in order to process a third set of instructions. In other words, in some instances some code has to be resolved (such as constant values being determined for the code) and that code be written. This rewritten code has to be executed such that subsequent code that uses or relies on some aspect of the first set of code then can be simafied.

In some embodiments, the system performs escape analysis or aliases to generate the slices of the callgraphs.

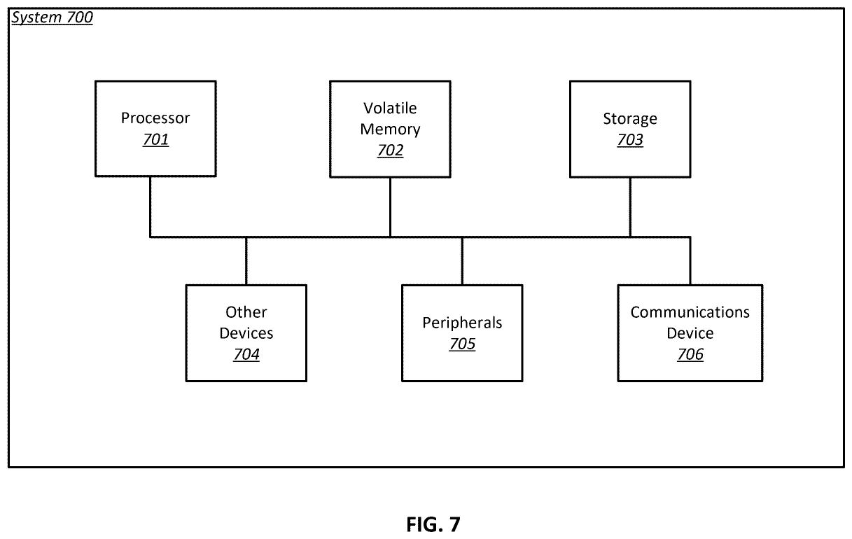

FIG. 7 is a diagram illustrating an exemplary computer that may perform processing in some embodiments. Exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as, e.g., hard drives, solid-state drives, or flash drives. Communications device 706 may connect the computer 700 to an external medium. For example, communications device 706 may take the form of a network adapter that provides communications to a network. A computer 700 may also include a variety of other devices 704. The various components of the computer 700 may be connected by a connection medium such as a bus, crossbar, or network.

It will be appreciated that the present disclosure may include any one and up to all of the following examples.

### Examples

Example 1. A method for generating replacement code for a computer program, method the comprising the operations of: receiving a computer program comprising code; generating a callgraph of the received computer program; determining a plurality of occurrences of sets of the instructions in the code that will reproduce the same computed results when the code is executed; for each determined plurality of occurrences of the instructions: generating a new set of instructions describing the computed results, and updating the computer program by replacing the occurrences of instructions in the code with the generated new set of instructions describing the computed results.

Example 2. The method of Example 1, wherein determining a plurality of occurrences of instructions comprises: determining whether an input to a function includes values that are constant.

Example 3. The method of any of Examples 1-2, wherein determining a plurality of occurrences of instructions comprises: determining that a set of instructions does not branch variably branch to two or more different sets of instructions.

Example 4. The method of any of Examples 1-3, wherein determining a plurality of occurrences of instructions comprises: determining that a set of instructions includes a computation performing an arithmetic operation on two or more constant values.

Example 5. The method of any of Examples 1-4, for each determined plurality of occurrences of the instructions, further performing: generating a super slice callgraph for the determined plurality of occurrences of instructions and their respective computed results.

Example 6. The method of any of Examples 1-5, wherein determining a plurality of occurrences of instructions comprises: determining that a set of instructions does not include a run-time or dynamic variable value.

Example 7. The method of any of Examples 1-6, wherein determining a plurality of occurrences of instructions comprises: determining that a set of instructions includes a static string value.

Example 8. The method of any of Examples 1-7, further comprising: defining a set of commands to search, wherein the set of commands are associated with a computer programming language type.

Example 9. The method of any of Examples 1-8, further comprising: evaluating the received computer program to identify a computer programming language type, and using the defined set of commands associated with the computer programming language type.

Example 10. The method of any of Examples 1-9, wherein determining the computer programming language type comprises: evaluating a file type associated with the received computer program and selecting a computer programming language type based on the file type.

Example 11. The method of any of Examples 1-10, wherein determining the computer programming language type comprises: evaluating a file type associated with the received computer program and selecting a computer programming language type based on the file type.

Example 12. The method of any of Examples 1-11, wherein the plurality of occurrences of sets of the instructions in the code include instructions to read a file and assign one or more values to a variable in the received computer program.

Example 13. The method of any of Examples 1-12, wherein the plurality of occurrences of sets of the instructions in the code include instructions that perform operations on constant values in the received computer program.

Example 14. The method of any of Examples 1-13, further comprising: generating a report listing the plurality of occurrences of sets of the instructions and the associated replacement instructions for the computed results.

Example 15. The method of any of Examples 1-14, further comprising: displaying portions of original code from the received program and replacement code; receiving an input to revert the replacement code with the original code; and generating another program including at least some replacement code and reverted original code.

Example 16. A non-transitory computer-readable medium containing instructions for generating replacement code for a computer program comprising the operations of: receiving a computer program comprising code; generating a callgraph of the received computer program; determining a plurality of occurrences of sets of the instructions in the code that will reproduce the same computed results when the code is executed; for each determined plurality of occurrences of the instructions: generating a new set of instructions describing the computed results, and updating the computer program by replacing the occurrences of instructions in the code with the generated new set of instructions describing the computed results.

Example 17. The non-transitory computer-readable medium of any one of Examples 16, wherein determining a plurality of occurrences of instructions comprises: determining whether an input to a function includes values that are constant.

Example 18. The non-transitory computer-readable medium of any one of Examples 16-17, wherein determining a plurality of occurrences of instructions comprises: determining that a set of instructions does not branch variably branch to two or more different sets of instructions.

Example 19. The non-transitory computer-readable medium of any one of Examples 16-18, wherein determining a plurality of occurrences of instructions comprises: determining that a set of instructions includes a computation performing an arithmetic operation on two or more constant values.

Example 20. The non-transitory computer-readable medium of any one of Examples 16-19, for each determined plurality of occurrences of the instructions, further performing: generating a super slice callgraph for the determined plurality of occurrences of instructions and their respective computed results.

Example 21. The non-transitory computer-readable medium of any one of Examples 16-20, wherein determining a plurality of occurrences of instructions comprises: determining that a set of instructions does not include a run-time or dynamic variable value.

Example 22. The non-transitory computer-readable medium of any one of Examples 16-21, wherein determining a plurality of occurrences of instructions comprises: determining that a set of instructions includes a static string value.

Example 23. The non-transitory computer-readable medium of any one of Examples 16-22, further comprising: defining a set of commands to search, wherein the set of commands are associated with a computer programming language type.

Example 24. The non-transitory computer-readable medium of any one of Examples 16-23, further comprising: evaluating the received computer program to identify a computer programming language type and using the defined set of commands associated with the computer programming language type.

Example 25. The non-transitory computer-readable medium of any one of Examples 16-24, wherein determining the computer programming language type comprises: evaluating a file type associated with the received computer program and selecting a computer programming language type based on the file type.

Example 26. The non-transitory computer-readable medium of any one of Examples 16-25, wherein determining the computer programming language type comprises: evaluating a file type associated with the received computer program and selecting a computer programming language type based on the file type.

Example 27. The non-transitory computer-readable medium of any one of Examples 16-26, wherein the plurality of occurrences of sets of the instructions in the code include instructions to read a file and assign one or more values to a variable in the received computer program.

Example 28. The non-transitory computer-readable medium of any one of Examples 16-27, wherein the plurality of occurrences of sets of the instructions in the code include instructions that perform operations on constant values in the received computer program.

Example 29. The non-transitory computer-readable medium of any one of Examples 16-29, further comprising: generating a report listing the plurality of occurrences of sets of the instruction and the associated replacement instructions for the computed results.

Example 30. The non-transitory computer-readable medium of any one of Examples 16-30, further comprising: displaying portions of original code from the received program and replacement code; receiving an input to revert the replacement code with the original code; and generating another program including at least some replacement code and reverted original code.

Example 31. A system comprising one or more processors configured to perform the operations of: receiving a computer program comprising code; generating a callgraph of the received computer program; determining a plurality of occurrences of sets of the instructions in the code that will reproduce the same computed results when the code is executed; for each determined plurality of occurrences of the instructions: generating a new set of instructions describing the computed results, and updating the computer program by replacing the occurrences of instructions in the code with the generated new set of instructions describing the computed results.

Example 32. The system of Example 31, wherein determining a plurality of occurrences of instructions comprises: determining whether an input to a function includes values that are constant.

Example 33. The system of any one of Examples 31-32, wherein determining a plurality of occurrences of instructions comprises: determining that a set of instructions does not branch variably branch to two or more different sets of instructions.

Example 34. The system of any one of Examples 31-33, wherein determining a plurality of occurrences of instructions comprises: determining that a set of instructions includes a computation performing an arithmetic operation on two or more constant values.

Example 23. The system of any one of Examples 31-34, for each determined plurality of occurrences of the instructions, further performing: generating a super slice callgraph for the determined plurality of occurrences of instructions and their respective computed results.

Example 36. The system of any one of Examples 31-35, wherein determining a plurality of occurrences of instructions comprises: determining that a set of instructions does not include a run-time or dynamic variable value.

Example 37. The system of any one of Examples 31-36, wherein determining a plurality of occurrences of instructions comprises: determining that a set of instructions includes a static string value.

Example 38. The system of any one of Examples 31-37, further comprising: defining a set of commands to search, wherein the set of commands are associated with a computer programming language type.

Example 39. The system of any one of Examples 31-38, further comprising: evaluating the received computer program to identify a computer programming language type and using the defined set of commands associated with the computer programming language type.

Example 40. The system of any one of Examples 31-39, wherein determining the computer programming language type comprises: evaluating a file type associated with the received computer program and selecting a computer programming language type based on the file type.

Example 41. The system of any one of Examples 31-40, wherein determining the computer programming language type comprises: evaluating a file type associated with the received computer program and selecting a computer programming language type based on the file type.

Example 42. The system of any one of Examples 31-41, wherein the plurality of occurrences of sets of the instructions in the code include instructions to read a file and assign one or more values to a variable in the received computer program.

Example 43. The system of any one of Examples 31-42, wherein the plurality of occurrences of sets of the instructions in the code include instructions that perform operations on constant values in the received computer program.

Example 44. The system of any one of Examples 31-43, further comprising: generating a report listing the plurality of occurrences of sets of the instruction and the associated replacement instructions for the computed results.

Example 45. The system of any one of Examples 44-44, further comprising: displaying portions of original code from the received program and replacement code; receiving an input to revert the replacement code with the original code; and generating another program including at least some replacement code and reverted original code.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for generating replacement code for a computer program, method the comprising the operations of:
receiving a computer program comprising code;
generating a callgraph of the received computer program;
determining a plurality of occurrences of sets of the instructions in the code that will reproduce the same computed results when the code is executed;
for each determined plurality of occurrences of the instructions:
computing the results of the instructions;
generating a new set of instructions describing the computed results; and
updating the computer program by replacing the occurrences of instructions in the code with the generated new set of instructions describing the computed results.

2. The method of claim 1, wherein determining a plurality of occurrences of instructions comprises:
determining whether an input to a function includes values that are constant.

3. The method of claim 1, wherein determining a plurality of occurrences of instructions comprises:
determining that a set of instructions does not branch variably branch to two or more different sets of instructions.

4. The method of claim 1, wherein determining a plurality of occurrences of instructions comprises:
determining that a set of instructions includes a computation performing an arithmetic operation on two or more constant values.

5. The method of claim 1, for each determined plurality of occurrences of the instructions, further performing:
generating a super slice callgraph for the determined plurality of occurrences of instructions and their respective computed results.

6. The method of claim 1, wherein determining a plurality of occurrences of instructions comprises:
determining that a set of instructions does not include a run-time or dynamic variable value.

7. The method of claim 1, wherein determining a plurality of occurrences of instructions comprises:
determining that a set of instructions includes a static string value.

8. A non-transitory computer-readable medium containing instructions for generating replacement code for a computer program comprising the operations of:
receiving a computer program comprising code;
generating a callgraph of the received computer program;
determining a plurality of occurrences of sets of the instructions in the code that will reproduce the same computed results when the code is executed;
for each determined plurality of occurrences of the instructions:
computing the results of the instructions;
generating a new set of instructions describing the computed results; and
updating the computer program by replacing the occurrences of instructions in the code with the generated new set of instructions describing the computed results.

9. The non-transitory computer-readable medium of claim 8, wherein determining a plurality of occurrences of instructions comprises:
determining whether an input to a function includes values that are constant.

10. The non-transitory computer-readable medium of claim 8, wherein determining a plurality of occurrences of instructions comprises:
determining that a set of instructions does not branch variably branch to two or more different sets of instructions.

11. The non-transitory computer-readable medium of claim 8, wherein determining a plurality of occurrences of instructions comprises:
determining that a set of instructions includes a computation performing an arithmetic operation on two or more constant values.

12. The non-transitory computer-readable medium of claim 8, for each determined plurality of occurrences of the instructions, further performing:
generating a super slice callgraph for the determined plurality of occurrences of instructions and their respective computed results.

13. The non-transitory computer-readable medium of claim 8, determining a plurality of occurrences of instructions comprises:
determining that a set of instructions does not include a run-time or dynamic variable value.

14. The non-transitory computer-readable medium of claim 8, determining a plurality of occurrences of instructions comprises:
determining that a set of instructions includes static string values.

15. A system comprising one or more processors configured to perform the operations of:
receiving a computer program comprising code, wherein the code comprises machine language code including multiple instructions;
receiving a computer program comprising code;
generating a callgraph of the received computer program;
determining a plurality of occurrences of sets of the instructions in the code that will reproduce the same computed results when the code is executed;
for each determined plurality of occurrences of the instructions:
computing the results of the instructions;
generating a new set of instructions describing the computed results; and
updating the computer program by replacing the occurrences of instructions in the code with the generated new set of instructions describing the computed results.

16. The system of claim 15, wherein determining a plurality of occurrences of instructions comprises:
determining whether an input to a function includes values that are constant.

17. The system of claim 15, wherein determining a plurality of occurrences of instructions comprises:
determining that a set of instructions does not branch variably branch to two or more different sets of instructions.

18. The system of claim 15, wherein determining a plurality of occurrences of instructions comprises:
determining that a set of instructions includes a computation performing an arithmetic operation on two or more constant values.

19. The system of claim 15, for each determined plurality of occurrences of the instructions, further performing:
generating a super slice callgraph for the determined plurality of occurrences of instructions and their respective computed results.

20. The system of claim 15, wherein determining a plurality of occurrences of instructions comprises:
determining that a set of instructions does not include a run-time or dynamic variable value.

21. The system of claim 15, wherein determining a plurality of occurrences of instructions comprises:
determining that a set of instructions includes a static string value.
